(19) United States
(12) Patent Application Publication
(10) Pub. No.: US 2026/0136390 A1
(43) Pub. Date: May 14, 2026

(54) METHOD AND APPARATUS FOR SCHEDULING DIRECT COMMUNICATION IN WIRELESS LAN

(71) Applicant: Electronics and Telecommunications Research Institute, Daejeon (KR)

(72) Inventors: Sung Hyun HWANG, Daejeon (KR); Kyu Min KANG, Daejeon (KR); Yong Ho KIM, Incheon (KR); Ju Seong MOON, Osan-si, Gyeonggi-do (KR)

(21) Appl. No.: 19/118,098

(22) PCT Filed: Oct. 18, 2023
(86) PCT No.: PCT/KR2023/016153

§ 371 Date: Apr. 3, 2025

(30) Foreign Application Priority Data
Oct. 18, 2022 (KR) 10-2022-0134315
Mar. 2, 2023 (KR) 10-2023-0028105
Oct. 16, 2023 (KR) 10-2023-0137829

(51) Int. Cl. H04W 74/0816; H04L 5/00; H04W 76/14

(52) U.S. Cl. CPC H04W 74/0816; H04L 5/0053; H04W 76/14

(57) ABSTRACT

Disclosed are a method and an apparatus for scheduling direct communication in a wireless LAN. A method of an STA MLD comprises the steps of: transmitting a first frame that requests use of a link for direct communication to an AP MLD on a first link; receiving a second frame from the AP MLD on the first link in response to the request to use a link for direct communication; and performing the direct communication in a TWT SP of a second link established by an exchange procedure of the first frame and the second frame.

### TECHNICAL FIELD

The present disclosure relates to a wireless local area network (LAN) communication technique, and more particularly, to a technique for scheduling direction communication in a wireless LAN supporting a multi-link.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multi-access point (AP) transmission operations, and/or efficient retransmission operations (e.g., hybrid automatic repeat request (HARQ) operations).

However, since a multi-link operation is an operation not defined in the existing wireless LAN standard, it may be required to define detailed operations according to an environment in which the multi-link operation is performed. In particular, a device (e.g., station (STA), access point (AP), multi-link device (MLD)) supporting enhanced multi-link single radio (EMLSR) operations may wait for reception in a multi-link. The device supporting EMLSR operations may be referred to as an EMLSR device.

When an EMLSR device starts transmitting and receiving frame(s) on a single link, the EMLSR device may operate only on the single link. In other words, the EMLSR device cannot transmit/receive frame(s) in other links while performing frame transmission/reception on the single link. Interference may occur between multiple links. Transmissions on one link may cause interference on the other link(s). Due to the interference, additional detailed operations may be required for communication on multiple links. Depending on the additional detailed operations, definition of operations for direct communication on multiple links and/or scheduling of direct communication may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for scheduling direction communication in a wireless LAN supporting a multi-link.

### Technical Solution

A method of a STA MLD, according to exemplary embodiments of the present disclosure for achieving the above-described objective, may comprise: transmitting a first frame including a request for use of a link for direct communication to an access point (AP) MLD on a first link; receiving a second frame from the AP MLD on the first link in response to the request for use of the link for direct communication; and performing direct communication in a target wake time (TWT) service period (SP) of a second link, which is configured by an exchange procedure of the first frame and the second frame.

The first frame may include information on at least one of the second link on which the STA MLD wishes to perform the direct communication or the TWT SP.

The second frame may include information on at least one of the second link on which the direct communication of the STA MLD is allowed or the TWT SP.

The method may further comprise: before the TWT SP, performing communication with the AP MLD in a transmit opportunity (TXOP) on one link among the first link and the second link, wherein in response that the first link and the second link are a non-simultaneous transmit and receive (NSTR) link pair, the TXOP is configured to be terminated before a MediumSyncDelay time from a start time of the TWT SP, or the TXOP is early terminated before the MediumSyncDelay time from the start time of the TWT SP.

The method may further comprise: before the TWT SP, performing communication with the AP MLD in a TXOP on one link among the first link and the second link, wherein in response that the first link and the second link are an NSTR link pair, and the STA MLD is an enhanced multi-link single radio (EMLSR) MLD, the TXOP is configured to be terminated before (MediumSyncDelay time+EMLSR transition time) from a start time of the TWT SP, or the TXOP is early terminated before (MediumSyncDelay time+EMLSR transition time) from the start time of the TWT SP.

The STA MLD may not expect to receive a frame from the AP MLD on the first link that has an NSTR link pair relationship with the second link, during a time corresponding to the TWT SP of the second link.

In response that the first link and the second link are an NSTR link pair, the TWT SP may be configured to include a MediumSyncDelay time, and the direct communication may be performed in a time remaining after the MediumSyncDelay time is terminated within the TWT SP.

In response that the first link and the second link are an NSTR link pair, and the TWT SP partially overlaps with a MediumSyncDelay time, the direct communication may be performed in a time corresponding to (a part of the TWP SP that does not overlap the MediumSyncDelay time +an additional time allocated by the AP MLD).

The method may further comprise: in response that the direct communication is terminated, transmitting a third frame for early terminating the TWT SP; and early terminating the TWT SP after transmission of the third frame.

A method of an AP MLD, according to exemplary embodiments of the present disclosure for achieving the above-described objective, may comprise: receiving a first frame including a request for use of a link for direct communication from a station (STA) MLD on a first link; determining a second link on which the direct communication is to be performed and a target wake time (TWT) service period (SP) based on information included in the first frame; and transmitting a second frame including information of the second link and information of the TWT SP to the STA MLD on the first link, wherein the AP MLD does not perform communication with the STA MLD on the first link that has a non-simultaneous transmit and receive (NSTR) link pair relationship with the second link, during a time corresponding to the TWT SP of the second link.

The method may further comprise: before the TWT SP, performing communication with the STA MLD in a transmit opportunity (TXOP) on one link among the first link and the second link,

wherein the TXOP is configured to be terminated before a MediumSyncDelay time from a start time of the TWT SP, or the TXOP is early terminated before the MediumSyncDelay time from the start time of the TWT SP.

The method may further comprise: before the TWT SP, performing communication with the STA MLD in a TXOP on one link among the first link and the second link, wherein in response that the STA MLD is an EMLSR MLD, the TXOP is configured to be terminated before (MediumSyncDelay time+EMLSR transition time) from a start time of the TWT SP, or the TXOP is early terminated before (MediumSyncDelay time+EMLSR transition time) from the start time of the TWT SP.

The method may further comprise: in response that the first link and the second link are an NSTR link pair, and the TWT SP overlaps with a MediumSyncDelay time, allocating an additional time to the STA MLD, wherein the direct communication of the STA MLD is performed in a time corresponding to (a part of the TWP SP that does not overlap the MediumSyncDelay time+the additional time allocated by the AP MLD).

The method may further comprise: in response that the direct communication is terminated, receiving a third frame for early terminating the TWT SP from the STA MLD; and early terminating the TWT SP after reception of the third frame.

A STA MLD, according to exemplary embodiments of the present disclosure for achieving the above-described objective, may comprise at least one processor, and the at least one processor may cause the STA MLD to perform: transmitting a first frame including a request for use of a link for direct communication to an access point (AP) MLD on a first link; receiving a second frame from the AP MLD on the first link in response to the request for use of the link for direct communication; and performing direct communication in a target wake time (TWT) service period (SP) of a second link, which is configured by an exchange procedure of the first frame and the second frame.

The at least one processor may further cause the STA MLD to perform: before the TWT SP, performing communication with the AP MLD in a transmit opportunity (TXOP) on one link among the first link and the second link, wherein in response that the first link and the second link are a non-simultaneous transmit and receive (NSTR) link pair, the TXOP is configured to be terminated before a MediumSyncDelay time from a start time of the TWT SP, or the TXOP is early terminated before the MediumSyncDelay time from the start time of the TWT SP.

The at least one processor may further cause the STA MLD to perform: before the TWT SP, performing communication with the AP MLD in a TXOP on one link among the first link and the second link, wherein in response that the first link and the second link are an NSTR link pair, and the STA MLD is an enhanced multi-link single radio (EMLSR) MLD, the TXOP is configured to be terminated before (MediumSyncDelay time+EMLSR transition time) from a start time of the TWT SP, or the TXOP is early terminated before (MediumSyncDelay time+EMLSR transition time) from the start time of the TWT SP.

In response that the first link and the second link are an NSTR link pair, the TWT SP may be configured to include a MediumSyncDelay time, and the direct communication may be performed in a time remaining after the MediumSyncDelay time is terminated within the TWT SP.

In response that the first link and the second link are an NSTR link pair, and the TWT SP partially overlaps with a MediumSyncDelay time, the direct communication may be performed in a time corresponding to (a part of the TWP SP that does not overlap the MediumSyncDelay time +an additional time allocated by the AP MLD).

The at least one processor may further cause the STA MLD to perform: in response that the direct communication is terminated, transmitting a third frame for early terminating the TWT SP; and early terminating the TWT SP after transmission of the third frame.

### Advantageous Effects

According to the present disclosure, a communication node (e.g., STA, AP, MLD) operating on multiple links can configure direct communication scheduling to perform direct communication. The direct communication scheduling can be configured on multiple links where communication nodes operate or on a dedicated link used for direct communication. Direct communication period(s) can be configured by the direct communication scheduling. In the direct communication period(s), the communication nodes can perform direct communication.

The AP (e.g., AP MLD) may stop transmission to a STA (e.g., STA MLD) for which the direct communication period is configured before the direct communication period. The STA (e.g., STA MLD) for which the direct communication period is configured may stop transmission before the direct communication period. In the direct communication period, the AP may not transmit data (e.g., data frame) to the STA performing direct communication. The direct communication period may be terminated early. The direct communication scheduling may be terminated early. The direct communication period and/or direct communication scheduling may be coordinated. Accordingly, direct communication can be performed smoothly in a wireless LAN that supports multiple links.

### DESCRIPTION OF DRAWINGS

FIG. 1 is a conceptual diagram illustrating a first exemplary embodiment of a wireless LAN system.

FIG. 2 is a block diagram illustrating a first exemplary embodiment of a communication node constituting a wireless LAN system.

FIG. 3 is a conceptual diagram illustrating a first exemplary embodiment of a multi-link configured between multi-link devices (MLDs).

FIG. 4 is a sequence chart illustrating a first exemplary embodiment of a negotiation procedure for a multi-link operation in a wireless LAN system.

FIG. 5 is a timing diagram illustrating a first exemplary embodiment of a direct communication scheduling method in a wireless LAN.

FIG. 6 is a timing diagram illustrating a second exemplary embodiment of a direct communication scheduling method in a wireless LAN.

FIG. 7 is a timing diagram illustrating a third exemplary embodiment of a direct communication scheduling method in a wireless LAN.

FIG. 8A is a timing diagram illustrating a fourth exemplary embodiment of a direct communication scheduling method in a wireless LAN.

FIG. 8B is a timing diagram illustrating a fifth exemplary embodiment of a direct communication scheduling method in a wireless LAN.

FIG. 8C is a timing diagram illustrating a sixth exemplary embodiment of a direct communication scheduling method in a wireless LAN.

FIG. 9A is a timing diagram illustrating a seventh exemplary embodiment of a direct communication scheduling method in a wireless LAN.

FIG. 9B is a timing diagram illustrating an eighth exemplary embodiment of a direct communication scheduling method in a wireless LAN.

FIG. 10A is a timing diagram illustrating a ninth exemplary embodiment of a direct communication scheduling method in a wireless LAN.

FIG. 10B is a timing diagram illustrating a tenth exemplary embodiment of a direct communication scheduling method in a wireless LAN.

FIG. 11 is a timing diagram illustrating an eleventh exemplary embodiment of a direct communication scheduling method in a wireless LAN.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

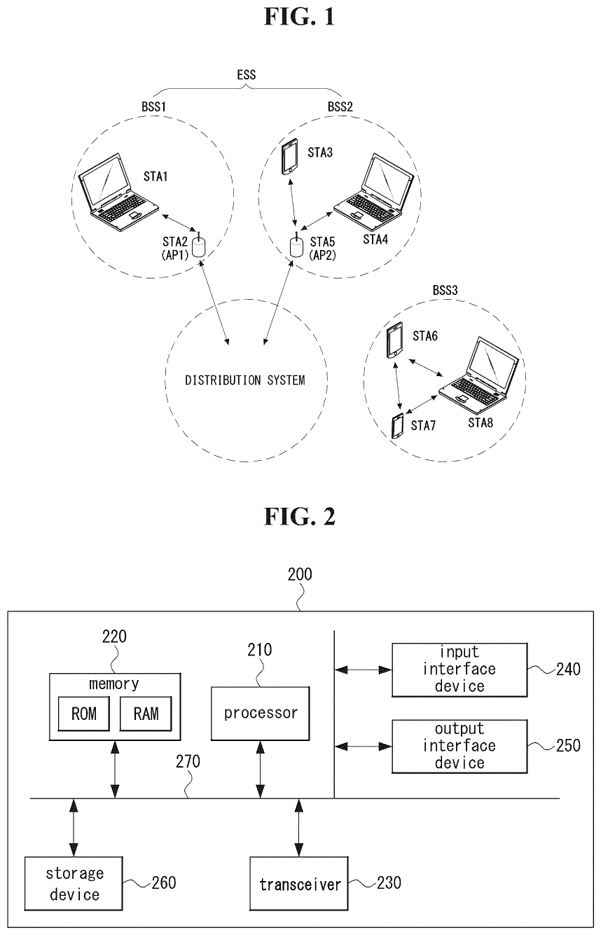

FIG. 1 is a conceptual diagram illustrating a first exemplary embodiment of a wireless LAN system.

Referring to FIG. 1, a wireless LAN system may include at least one basic service set (BSS). A BSS may refer to a set of stations (e.g., STA1, STA2 (AP1), STA3, STA4, STA5 (AP2), STA6, STA7, and STA8) that can communicate with each other through successful synchronization, and may not refer to a specific region. In exemplary embodiments below, a station performing functions as an access point may be referred to as an ‘access point (AP)’, and a station not performing functions as an access point may be referred to as a ‘non-AP station’ or a ‘station’.

The BSS may be classified into an infrastructure BSS and an independent BSS (IBSS). Here, a BSS1 and a BSS2 may mean infrastructure BSSs, and a BSS3 may mean an IBSS. The BSS1 may include a first station (STA1), a first access point (STA2 (AP1)) providing a distribution service, and a distribution system (DS) connecting a plurality of access points (STA2 (AP1) and STA5 (AP2)). In the BSS1, the first access point STA2 (AP1) may manage the first station STA1.

The BSS2 may include a third station (STA3), a fourth station (STA4), a second access point (STA5 (AP2)) providing a distribution service, and a DS connecting the plurality of access points (STA2 (AP1) and STA5 (AP2)). In the BSS2, the second access point STA5 (AP2) may manage the third station STA3 and the fourth station STA4.

The BSS3 may mean an IBSS operating in an ad-hoc mode. An access point, which is a centralized management entity, may not exist in the BSS3. That is, in the BSS3, the stations STA6, STA7, and STA8 may be managed in a distributed manner. In the BSS3, all stations STA6, STA7, and STA8 may refer to mobile stations, and since they are not allowed to access a DS, they may constitute a self-contained network.

The access points STA2 (AP1) and STA5 (AP2) may provide access to the DS for the stations STA1, STA3, and STA4 associated therewith via a wireless medium. In the BSS1 or BSS2, communications between the stations STA1, STA3, and STA4 are generally performed through the access points STA2 (AP1) and STA5 (AP2), but when direct links are established, direct communications between the stations STA1, STA3, and STA4 may be possible.

A plurality of infrastructure BSSs may be interconnected through a DS. The plurality of BSSs connected through the DS may be referred to as an extended service set (ESS). The communication nodes STA1, STA2 (AP1), STA3, STA4, and STA5 (AP2) included in the ESS may communicate with each other, and an arbitrary station (STA1, STA3, or STA4) may move from one BSS to another BSS within the same ESS while communicating without interruption.

The DS may be a mechanism for one access point to communicate with another access point, according to which an access point may transmit frames for stations associated with the BSS it manages, or transmit frames for an arbitrary station that has moved to another BSS. Also, the access point may transmit and receive frames to and from an external network such as a wired network. Such the DS may not necessarily have to be a network, and if it can provide a predetermined distribution service stipulated in the IEEE 802.11 standard, there is no restriction on its form. For example, the DS may be a wireless network such as a mesh network or a physical structure that connects the access points to each other. The communication nodes STA1, STA2 (AP1), STA3, STA4, STA5 (AP2), STA6, STA7, and STA8 included in the wireless LAN system may be configured as follows.

FIG. 2 is a block diagram illustrating a first exemplary embodiment of a communication node constituting a wireless LAN system.

Referring to FIG. 2, a communication node 200 may include at least one processor 210, a memory 220, and a transceiver 230 connected to a network to perform communications. The transceiver 230 may be referred to as a transceiver, a radio frequency (RF) unit, an RF module, or the like. In addition, the communication node 200 may further include an input interface device 240, an output interface device 250, a storage device 260, and the like. The respective components included in the communication node 200 may be connected by a bus 270 to communicate with each other.

However, the respective components included in the communication node 200 may be connected through individual interfaces or individual buses centering on the processor 210 instead of the common bus 270. For example, the processor 210 may be connected to at least one of the memory 220, the transceiver 230, the input interface device 240, the output interface device 250, and the storage device 260 through a dedicated interface.

The processor 210 may execute program commands stored in at least one of the memory 220 and the storage device 260. The processor 210 may refer to a central processing unit (CPU), a graphics processing unit (GPU), or a dedicated processor on which the methods according to the exemplary embodiments of the present invention are performed. Each of the memory 220 and the storage device 260 may be configured as at least one of a volatile storage medium and a nonvolatile storage medium. For example, the memory 220 may be configured with at least one of a read only memory (ROM) and a random access memory (RAM).

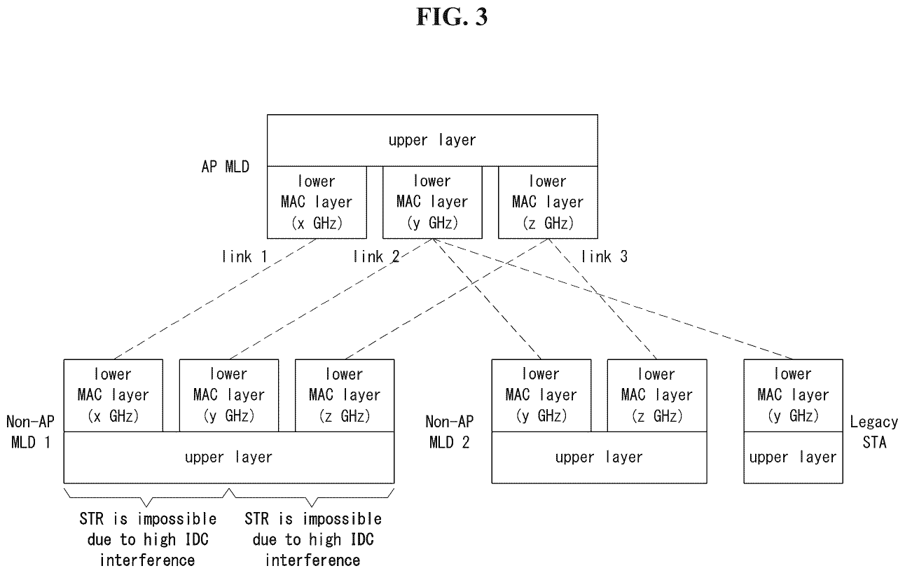

FIG. 3 is a conceptual diagram illustrating a first exemplary embodiment of a multi-link configured between multi-link devices (MLDs).

Referring to FIG. 3, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD). The AP of the AP MLD may mean an AP affiliated with the AP MLD. The STA of the STA MLD may mean a STA affiliated with the STA MLD.

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 210 shown in FIG. 2). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 210 shown in FIG. 2).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

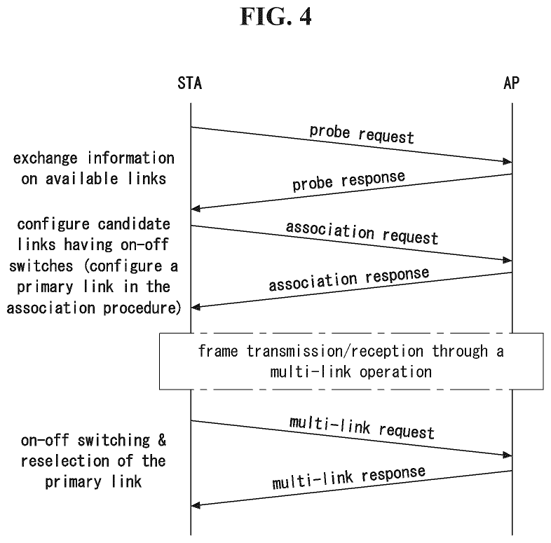

FIG. 4 is a sequence chart illustrating a first exemplary embodiment of a negotiation procedure for a multi-link operation in a wireless LAN system.

Referring to FIG. 4, an access procedure between an STA and an AP in an infrastructure basic service set (BSS) may generally be divided into a probe step of probing AP(s), an authentication step for authentication between the STA and the probed AP, and an association step of association between the STA and the authenticated AP.

In the probe step, the STA may detect one or more APs using a passive scanning scheme or an active scanning scheme. When the passive scanning scheme is used, the STA may detect one or more APs by overhearing beacons transmitted by the one or more APs. When the active scanning scheme is used, the STA may transmit a probe request frame, and may detect one or more APs by receiving probe response frames that are responses to the probe request frame from the one or more APs.

When the one or more APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In particular, the STA may select one AP among AP(s) with which the STA has performed the authentication step, and perform the association step with the selected AP. That is, the STA may transmit an association request frame to the selected AP, and may complete the association with the AP by receiving an association response frame that is a response to the association request frame from the selected AP.

Meanwhile, a multi-link operation may be supported in the wireless LAN system. A multi-link device (MLD) may include one or more STAs affiliated with the MLD. The MLD may be a logical entity. The MLD may be classified into an AP MLD and a non-AP MLD. Each STA affiliated with the AP MLD may be an AP, and each STA affiliated with the non-AP MLD may be a non-AP STA. In order to configure a multi-link, a multi-link discovery procedure, a multi-link setup procedure, and the like may be performed. The multi-link discovery procedure may be performed in the probe step between an STA and an AP. In this case, multi-link information elements (ML IEs) may be included in the beacon frame, the probe request frame, and/or the probe response frame.

For example, in order to perform a multi-link operation, in the probe step, the AP (e.g., AP affiliated with an MLD) may exchange information indicating whether the multi-link operation can be used and information on available link(s) with the STA (e.g., non-AP STA affiliated with an MLD). In a negotiation procedure for the multi-link operation (e.g., multi-link setup procedure), the STA may transmit information of link(s) to be used for the multi-link operation. The negotiation procedure for the multi-link operation may be performed in the access procedure (e.g., association step) between the STA and the AP, and information element(s) required for the multi-link operation may be configured or changed by an action frame in the negotiation procedure.

In addition, in the access procedure (e.g., association step) between the STA and the AP, available link(s) of the AP may be configured, and an identifier (ID) may be assigned to each link. Thereafter, in the negotiation procedure and/or change procedure for the multi-link operation, information indicating whether each link is activated may be transmitted, and the information may be expressed using the link ID(s).

The information indicating whether the multi-link operation can be used may be transmitted and received in a procedure of exchanging capability information element(s) (e.g., EHT capability information element(s)) between the STA and the AP. The capability information element(s) may include information of supporting band(s), information of supporting link(s) (e.g., ID(s) and/or number of supporting link(s)), information of links capable of simultaneous transmission and reception (STR) operations (e.g., information on bands of the links, information on a separation between the links), and/or the like. In addition, the capability information element(s) may include information that individually indicates a link capable of the STR operation.

In the present disclosure, operations of a STA MLD may be interpreted as operations of a STA affiliated with the STA MLD, and operations of a STA may be interpreted as operations of a STA MLD affiliated with the STA. Operations of an AP MLD may be interpreted as operations of an AP affiliated with the AP MLD, and operations of an AP may be interpreted as operations of an AP MLD affiliated with the AP.

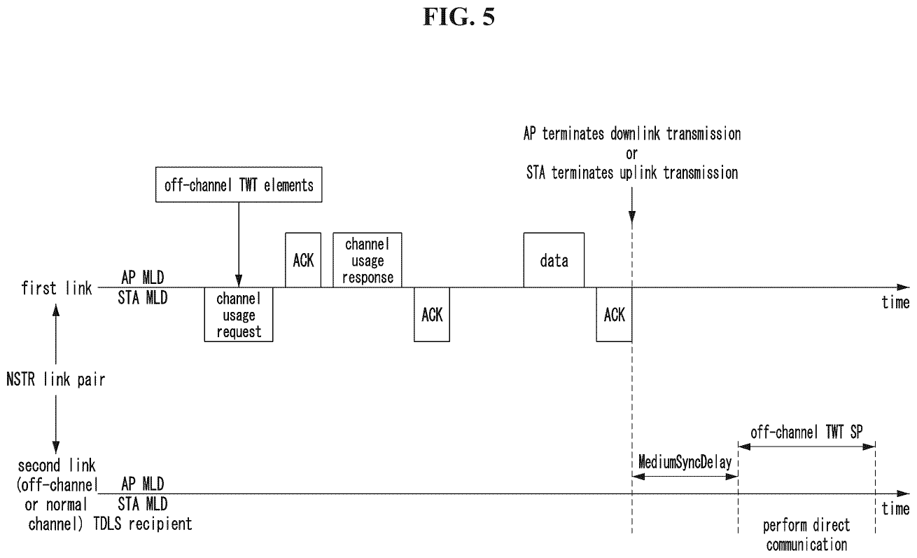

FIG. 5 is a timing diagram illustrating a first exemplary embodiment of a direct communication scheduling method in a wireless LAN.

Referring to FIG. 5, an AP MLD and a non-AP MLD (e.g., STA MLD) may operate on a multi-link. The STA MLD may perform direct communication (e.g., tunneled direct link setup (TDLS) operation, TDLS communication) on a second link. The second link may be one link of the multi-link on which the AP MLD and STA MLD operate. The second link may be a dedicated link (e.g., off-channel, off-link) for direct communication. A TDLS receiving STA (e.g., TDLS recipient) that is a target of direct communication may operate on the second link. The AP MLD may not operate on the off-channel. A first link and the second link may be a non-STR (NSTR) link pair for the STA MLD. The STA MLD may be an enhanced multi-link single radio (EMLSR) STA MLD. The first link and the second link may be EMLSR links. Exemplary embodiments according to the present disclosure may be applied to an EMLSR STA MLD (e.g., EMLSR operations). For example, if the STA MLD is an EMLSR STA MLD and the first link and the second link are EMLSR links, operations on the first link and the second link may be the same as or similar to operations on an NSTR link pair.

The STA MLD may transmit a channel usage request frame to the AP MLD to perform direct communication. The channel usage request frame may be referred to as a first frame. The AP MLD may receive the channel usage request frame from the STA MLD and identify information element(s) included in the channel usage request frame. The AP MLD may transmit a response frame for the channel usage request frame to the STA MLD. In the present disclosure, a response frame may mean an acknowledgment (ACK) frame or a block ACK (BA) frame. The channel usage request frame may be transmitted and received on the first link. The channel usage request frame may include information on a channel and/or link that the STA MLD wishes to use (e.g., information on the second link). In other words, the channel usage request frame may include information on a channel and/or link on which the STA MLD performs direct communication. The direct communication may be communication between STAs. The channel usage request frame may include one or more target wake time (TWT) information elements (e.g., TWT information, TWT elements). The TWT information elements may include a flow identifier (e.g., flow ID) that identifies a TWT request. The TWT information element(s) included in the channel usage request frame may indicate a TWT service period (SP) (e.g., off-channel TWT SP) in which the STA MLD wishes to perform direct communication. The TWT SP in which direct communication is performed may refer to a direct communication period.

The AP MLD may transmit a channel usage response frame to the STA MLD in response to the channel usage request frame. In other words, the AP MLD may determine a link and/or channel on which the STA MLD performs direct communication based on the information element(s) included in the channel usage request frame, and determine a TWP SP in which direct communication of the STA MLD is performed on the link and/or channel. The AP MLD may transmit to the STA MLD the channel usage response frame including information on the link and/or channel on which direct communication of the STA MLD is allowed and/or information on the TWT SP in which direct communication of the STA MLD is allowed. The STA MLD may receive the channel usage response frame from the AP MLD and identify the information element(s) included in the channel usage response frame. The STA MLD may transmit a response frame (e.g., ACK frame) for the channel usage response frame to the AP MLD. The channel usage response frame may be referred to as a second frame.

The channel usage response frame may include information on the channel and/or link requested by the STA MLD. In other words, the channel usage response frame may include information on the channel and/or link on which the STA MLD performs direct communication. The channel usage response frame may include one or more TWT information elements. In other words, the TWT information element(s) included in the channel usage response frame may indicate the TWT SP (e.g., off-channel TWT SP, direct communication period) in which the STA MLD performs direct communication. The channel usage response frame may include a timeout interval element.

By exchanging the channel usage request/response frames including TWT information element(s) between the STA MLD and AP MLD, TWT configuration (e.g., TWT agreement) for TDLS between the STA MLD and AP MLD may be negotiated. The channel usage request/response frames may refer to the channel usage request frame and/or the channel usage response frame. The TWT configuration for TDLS may be referred to as an off-channel TWT or an off-channel TWT agreement. A TWT SP scheduled based on the off-channel TWT agreement may be referred to as an off-channel TWT SP or an off-channel TWT schedule. The off-channel TWT agreement may be used until a time indicated by the timeout interval element included in the channel usage response frame transmitted by the AP MLD.

The off-channel TWT SP may be scheduled on the second link. The STA MLD may configure a transmit opportunity (TXOP) so that the TXOP is terminated before the off-channel TWT SP of the second link. Within the TXOP, communication between the STA MLD and AP MLD may be performed. Alternatively, the STA MLD may early terminate a TXOP before the off-channel TWT SP of the second link. The AP MLD may configure a TXOP so that the TXOP in which transmission to the STA MLD is performed is terminated before the off-channel TWT SP of the second link. Alternatively, the AP MLD may early terminate the TXOP before the off-channel TWT SP of the second link.

Since the first link and the second link on which the STA MLD operates are an NSTR link pair, the STA MLD may perform a standby operation (e.g., clear channel assessment (CCA) operation) without performing a transmission operation during a MediumSyncDelay time of the second link while transmission of the STA MLD is being performed on the first link. The MediumSyncDelay time may refer to a medium synchronization delay time. The MediumSyncDelay time may mean a time according to a MediumSyncDelay timer. In order to ensure that the STA MLD's direct communication is not affected by the MediumSyncDelay time, the STA MLD may configure a TXOP so that the TXOP is terminated before the MediumSyncDelay time from a start time of the off-channel TWT SP of the second link. Alternatively, the STA MLD may early terminate the TXOP before the MediumSyncDelay time from the start time of the off-channel TWT SP of the second link. The AP MLD may configure a TXOP in which transmission to the STA MLD is performed so that the TXOP is terminated before the MediumSyncDelay time from the start time of the off-channel TWT SP of the second link. Alternatively, the AP MLD may early terminate a TXOP in which transmission to the STA MLD is performed so that the TXOP is terminated before the MediumSyncDelay time from the start time of the off-channel TWT SP of the second link.

The STA MLD may be an EMLSR MLD (e.g., EMLSR STA MLD). If the STA MLD is an EMLSR MLD, an EMLSR transition delay, which is a transition time of transmission and reception operations between links, may be additionally required. To ensure that direct communication of the STA MLD is not affected by the MediumSyncDelay time and EMLSR transition delay, the STA MLD may configure a TXOP so that the TXOP is terminated before (MediumSyncDelay time +EMLSR transition delay) from the start time of the off-channel TWT SP of the second link. Alternatively, the STA MLD may early terminate a TXOP before the (MediumSyncDelay time +EMLSR transition delay) from the start time of the off-channel TWT SP of the second link. The AP MLD may configure a TXOP in which transmission to the STA MLD is performed so that the TXOP is terminated before (MediumSyncDelay time+EMLSR transition delay) from the start time of the off-channel TWT SP of the second link. Alternatively, the AP MLD may early terminate a TXOP in which transmission to the STA MLD is performed so that the TXOP is terminated before (MediumSyncDelay time+EMLSR transition delay) from the start time of the off-channel TWT SP of the second link.

The STA MLD may perform direct communication (e.g., peer-to-peer communication, TDLS communication) with a TDLS recipient (e.g., another STA, another STA MLD) in the off-channel TWT SP. The AP MLD may not transmit a frame to the STA MLD on the first link that has an NSTR link pair relationship with the second link during a time corresponding to the off-channel TWT SP of the second link. In other words, the STA MLD may not expect to receive a frame from the AP MLD on the first link that has an NSTR link pair relationship with the second link during a time corresponding to the off-channel TWT SP of the second link.

The STA MLD may perform CCA within the MediumSyncDelay time of the second link, and an energy level detected by CCA may be equal to or less than a predetermined value. If the energy level is equal to or less than the predetermined value, the STA MLD may transmit an RTS frame to the TDLS recipient on the second link. If the STA MLD transmits the RTS frame, the MediumSyncDelay time may be terminated early, and the STA MLD may perform communication within the off-channel TWT SP.

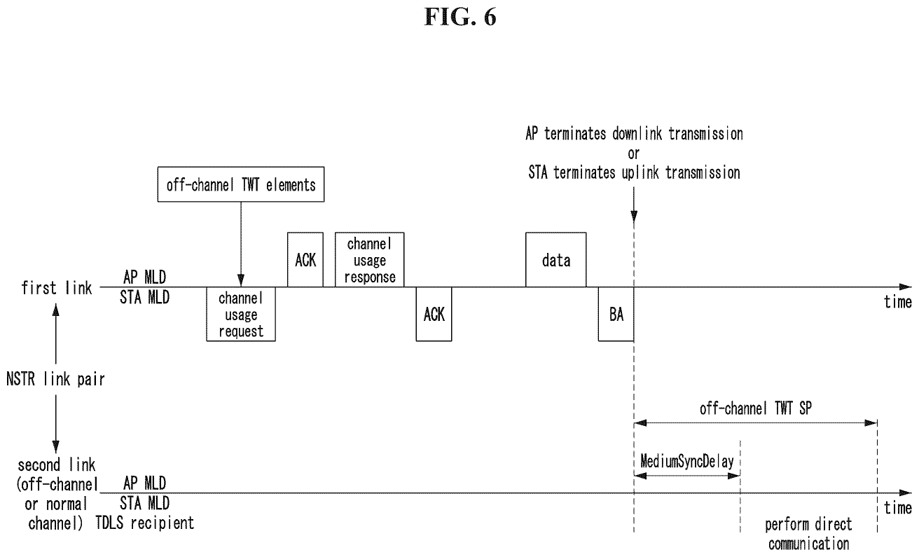

FIG. 6 is a timing diagram illustrating a second exemplary embodiment of a direct communication scheduling method in a wireless LAN.

Referring to FIG. 6, an AP MLD and a non-AP MLD (e.g., STA MLD) may operate on a multi-link. The STA MLD may perform direct communication (e.g., TDLS operation, TDLS communication) on a second link. The second link may be one link of the multi-link on which the AP MLD and STA MLD operate. The second link may be a dedicated link (e.g., off-channel, off-link) for direct communication. A TDLS receiving STA (e.g., TDLS recipient) that is a target of direct communication may operate on the second link. The AP MLD may not operate on the off-channel. A first link and the second link may be an NSTR link pair for the STA MLD. The STA MLD may be an EMLSR STA MLD. The first link and the second link may be EMLSR links. Exemplary embodiments according to the present disclosure may be applied to an EMLSR STA MLD (e.g., EMLSR operations). For example, if the STA MLD is an EMLSR STA MLD and the first link and the second link are EMLSR links, operations on the first link and the second link may be the same as or similar to operations on an NSTR link pair.

The STA MLD may transmit a channel usage request frame to the AP MLD to perform direct communication. The AP MLD may receive the channel usage request frame from the STA MLD and identify information element(s) included in the channel usage request frame. The AP MLD may transmit a response frame for the channel usage request frame to the STA MLD. The channel usage request frame may be transmitted and received on the first link. The channel usage request frame may include information on a channel and/or link that the STA MLD wishes to use (e.g., information on the second link). In other words, the channel usage request frame may include information on a channel and/or link on which the STA MLD performs direct communication. The channel usage request frame may include one or more TWT information elements (e.g., TWT information, TWT elements). The TWT information elements may include a flow identifier (e.g., flow ID) that identifies a TWT request. The TWT information element(s) included in the channel usage request frame may indicate a TWT SP (e.g., off-channel TWT SP, direct communication period) in which the STA MLD wishes to perform direct communication.

The AP MLD may transmit a channel usage response frame to the STA MLD in response to the channel usage request frame. In other words, the AP MLD may determine a link and/or channel on which the STA MLD performs direct communication based on the information element(s) included in the channel usage request frame, and determine a TWP SP in which direct communication of the STA MLD is performed on the link and/or channel. The AP MLD may transmit to the STA MLD the channel usage response frame including information on the link and/or channel on which direct communication of the STA MLD is allowed and/or information on the TWT SP in which direct communication of the STA MLD is allowed. The STA MLD may receive the channel usage response frame from the AP MLD and identify the information element(s) included in the channel usage response frame. The STA MLD may transmit a response frame for the channel usage response frame to the AP MLD. The channel usage response frame may include information on the channel and/or link requested by the STA MLD. The channel usage response frame may include one or more TWT information elements. The channel usage response frame may include a timeout interval element.

By exchanging the channel usage request/response frames including TWT information element(s) between the STA MLD and AP MLD, TWT configuration (e.g., TWT agreement) for TDLS between the STA MLD and AP MLD may be negotiated. The TWT configuration for TDLS may be referred to as an off-channel TWT or an off-channel TWT agreement. A TWT SP scheduled based on the off-channel TWT agreement may be referred to as an off-channel TWT SP or an off-channel TWT schedule. The off-channel TWT agreement may be used until a time indicated by the timeout interval element included in the channel usage response frame transmitted by the AP MLD.

The off-channel TWT SP may be scheduled on the second link. The STA MLD may configure a TXOP so that the TXOP is terminated before the off-channel TWT SP of the second link. Within the TXOP, communication between the STA MLD and AP MLD may be performed. Alternatively, the STA MLD may early terminate a TXOP before the off-channel TWT SP of the second link. The AP MLD may configure a TXOP in which transmission to the STA MLD is performed so that the TXOP is terminated before the off-channel TWT SP of the second link. Alternatively, the AP MLD may early terminate the TXOP before the off-channel TWT SP of the second link.

Since the first link and the second link on which the STA MLD operates are an NSTR link pair, the STA MLD may perform a standby operation (e.g., CCA operation) without performing a transmission operation during a MediumSyncDelay time of the second link while transmission of the STA MLD is being performed on the first link. In order to ensure that the STA MLD's direct communication is not affected by the MediumSyncDelay time, the off-channel TWP SP may be configured to include the MediumSyncDelay time. After the MediumSyncDelay time is terminated, the STA MLD may perform direct communication (e.g., peer-to-peer communication, TDLS communication) with a TDLS recipient within the remaining time of the off-channel TWT SP. For example, the remaining time of the off-channel TWT SP may be (length of the off-channel TWT SP-MediumSyncDelay time). The MediumSyncDelay time may be a time from a start time of the MediumSyncDelay timer to an end time of the MediumSyncDelay timer.

The STA MLD may be an EMLSR MLD (e.g., EMLSR STA MLD). If the STA MLD is an EMLSR MLD, an EMLSR transition delay, which is a transition time of transmission and reception operations between links, may be additionally required. To ensure that direct communication of the STA MLD is not affected by the MediumSyncDelay time and EMLSR transition delay, the off-channel TWT SP may be configured to include the MediumSyncDelay time and EMLSR transition delay time. After (EMLSR transition delay+MediumSyncDelay time) is terminated, within the remaining time of the off-channel TWT SP, the STA MLD may perform direct communication (e.g., peer-to-peer communication, TDLS communication) with the TDLS recipient. For example, the remaining time of the off-channel TWT SP may be (length of the off-channel TWT SP-EMLSR transition delay time-MediumSyncDelay time). The AP MLD may not transmit a frame to the STA MLD on the first link that has an NSTR link pair relationship with the second link during a time corresponding to the off-channel TWT SP of the second link. In other words, the STA MLD may not expect to receive a frame from the AP MLD on the first link that has an NSTR link pair relationship with the second link during a time corresponding to the off-channel TWT SP of the second link.

The STA MLD may perform CCA on the second link during the MediumSyncDelay time within the off-channel TWP SP, and an energy level detected by CCA may be equal to or less than a predetermined value. If the energy level is equal to or less than the predetermined value, the STA MLD may transmit an RTS frame to the TDLS recipient on the second link. If the STA MLD transmits the RTS frame, the MediumSyncDelay time may be terminated early, and the STA MLD may perform communication within the off-channel TWT SP.

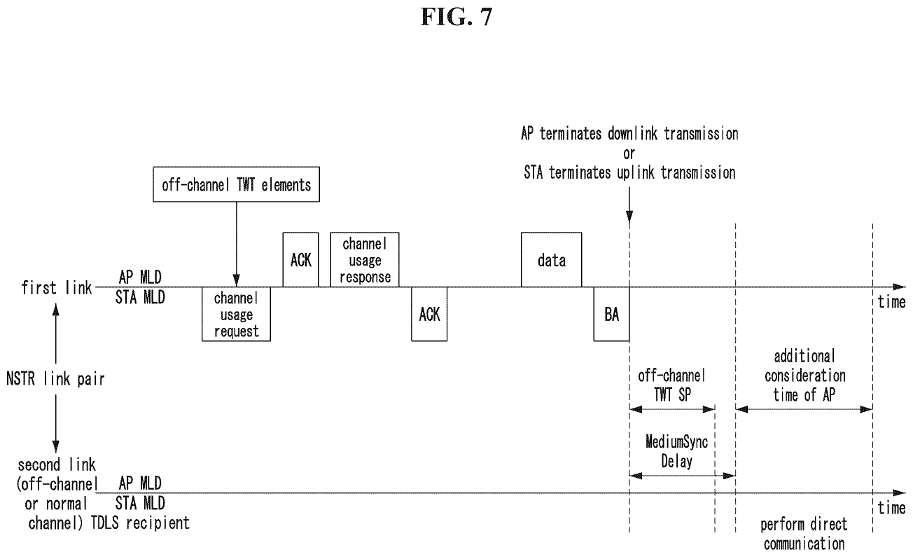

FIG. 7 is a timing diagram illustrating a third exemplary embodiment of a direct communication scheduling method in a wireless LAN.

Referring to FIG. 7, an AP MLD and a non-AP MLD (e.g., STA MLD) may operate on a multi-link. The STA MLD may perform direct communication (e.g., TDLS operation, TDLS communication) on a second link. The second link may be one link of the multi-link on which the AP MLD and STA MLD operate. The second link may be a dedicated link (e.g., off channel, off link) for direct communication. A TDLS receiving STA (e.g., TDLS recipient) that is a target of direct communication may operate on the second link. The AP MLD may not operate on the off-channel. A first link and the second link may be an NSTR link pair for the STA MLD. The STA MLD may be an EMLSR STA MLD. The first link and the second link may be EMLSR links. Exemplary embodiments according to the present disclosure may be applied to an EMLSR STA MLD (e.g., EMLSR operations). For example, if the STA MLD is an EMLSR STA MLD and the first link and the second link are EMLSR links, operations on the first link and the second link may be the same as or similar to operations on an NSTR link pair.

The STA MLD may transmit a channel usage request frame to the AP MLD to perform direct communication. The AP MLD may receive the channel usage request frame from the STA MLD and identify information element(s) included in the channel usage request frame. The AP MLD may transmit a response frame for the channel usage request frame to the STA MLD. The channel usage request frame may be transmitted and received on the first link. The channel usage request frame may include information on a channel and/or link that the STA MLD wishes to use (e.g., information on the second link). In other words, the channel usage request frame may include information on a channel and/or link on which the STA MLD performs direct communication. The channel usage request frame may include one or more TWT information elements (e.g., TWT information, TWT elements). The TWT information elements may include a flow identifier (e.g., flow ID) that identifies a TWT request. The TWT information element(s) included in the channel usage request frame may indicate a TWT SP (e.g., off channel TWT SP) in which the STA MLD wishes to perform direct communication.

The AP MLD may transmit a channel usage response frame to the STA MLD in response to the channel usage request frame. In other words, the AP MLD may determine a link and/or channel on which the STA MLD performs direct communication based on the information element(s) included in the channel usage request frame, and determine a TWP SP in which direct communication of the STA MLD is performed on the link and/or channel. The AP MLD may transmit to the STA MLD the channel usage response frame including information on the link and/or channel on which direct communication of the STA MLD is allowed and/or information on the TWT SP in which direct communication of the STA MLD is allowed. The STA MLD may receive the channel usage response frame from the AP MLD and identify the information element(s) included in the channel usage response frame. The STA MLD may transmit a response frame for the channel usage response frame to the AP MLD. The channel usage response frame may include information on the channel and/or link requested by the STA MLD. The channel usage response frame may include one or more TWT information elements. In other words, the TWT information element(s) included in the channel usage response frame may indicate the TWT SP (e.g., off-channel TWT SP, direct communication period) in which the STA MLD performs direct communication. The channel usage response frame may include a timeout interval element.

By exchanging the channel usage request/response frames including TWT information element(s) between the STA MLD and AP MLD, TWT configuration (e.g., TWT agreement) for TDLS between the STA MLD and AP MLD may be negotiated. The TWT configuration for TDLS may be referred to as an off-channel TWT or an off-channel TWT agreement. A TWT SP scheduled based on the off-channel TWT agreement may be referred to as an off-channel TWT SP or an off-channel TWT schedule. The off-channel TWT agreement may be used until a time indicated by the timeout interval element included in the channel usage response frame transmitted by the AP MLD.

The off-channel TWT SP may be scheduled on the second link. The STA MLD may configure a TXOP so that the TXOP is terminated before the off-channel TWT SP of the second link. Alternatively, the STA MLD may early terminate a TXOP before the off-channel TWT SP of the second link. The AP MLD may configure a TXOP in which transmission to the STA MLD is performed so that the TXOP is terminated before the off-channel TWT SP of the second link. Alternatively, the AP MLD may early terminate the TXOP before the off-channel TWT SP of the second link

Since the first link and the second link on which the STA MLD operates are an NSTR link pair, the STA MLD may perform a standby operation (e.g., CCA operation) without performing a transmission operation during a MediumSyncDelay time of the second link while transmission of the STA MLD is being performed on the first link. The off-channel TWT may overlap partially or fully with MediumSyncDelay time. In this case, the STA MLD may not be able to perform direct communication. In the above-described situation, in order to ensure that the direct communication of the STA MLD is not affected by the MediumSyncDelay time, the AP MLD may consider the MediumSyncDelay time of the STA MLD.

For example, when the AP MLD receives a frame from the STA MLD on the first link, the AP MLD may determine (e.g., predict) that the MediumSyncDelay timer is applied on the second link of the STA MLD, and predict an end time of the MediumSyncDelay timer (e.g., MediumSyncDelay time). When the MediumSyncDelay timer of the STA MLD is applied, the end time of the MediumSyncDelay timer is predicted, and the MediumSyncDelay time overlaps with the off-channel TWT SP, the AP MLD may calculate an additional consideration time. The AP MLD may allocate the additional consideration time to the STA MLD, and the STA MLD may identify the additional consideration time allocated by the AP MLD. The additional consideration time may be referred to as an additional time. The additional consideration time may be applied differently depending on condition(s) below.

Condition 1: If the off-channel TWT SP fully overlaps the MediumSyncDelay time, the additional consideration time may be a time corresponding to the length of the off-channel TWT SP, a time shorter than the length of the off-channel TWT SP, or a time equal to or longer than the length of the off-channel TWT SP.

Condition 2: If the off-channel TWT SP partially overlaps the MediumSyncDelay time, the additional consideration time may be a time corresponding to the length of a part of the off-channel TWT SP which overlaps with the MediumSyncDelay time, a time shorter than the length of the part of the off-channel TWT SP which overlaps with the MediumSyncDelay time, or a time equal to or longer than the length of the part of the off-channel TWT SP which overlaps with the MediumSyncDelay time.

The additional consideration time of the AP MLD may be applied after the end time of the MediumSyncDelay timer of the STA MLD. The STA MLD may perform direct communication (e.g., peer-to-peer communication, TDLS communication) with a TDLS recipient within (off-channel TWT SP (e.g., a part of the off-channel TWT SP that does not overlap the MediumSyncDelay time) +additional consideration time of the AP MLD). The AP MLD may not transmit a frame to the STA MLD on the first link that has an NSTR link pair relationship with the second link during a time corresponding to (off-channel TWT SP of the second link (e.g., a part of the off-channel TWT SP that does not overlap the MediumSyncDelay time)+additional consideration time of the AP MLD). In other words, the STA MLD may not expect to receive a frame from the AP MLD on the first link that has an NSTR link pair relationship with the second link during the time corresponding to (off-channel TWT SP of the second link (e.g., a part of the off-channel TWT SP that does not overlap the MediumSyncDelay time)+additional consideration time of the AP MLD).

The STA MLD may perform CCA within the MediumSyncDelay time of the second link, and an energy level detected by CCA may be equal to or less than a predetermined value. If the energy level is equal to or less than the predetermined value, the STA MLD may transmit an RTS frame to the TDLS recipient on the second link. If the STA MLD transmits the RTS frame, the MediumSyncDelay time may be terminated early, and the STA MLD may perform communication within the off-channel TWT SP.

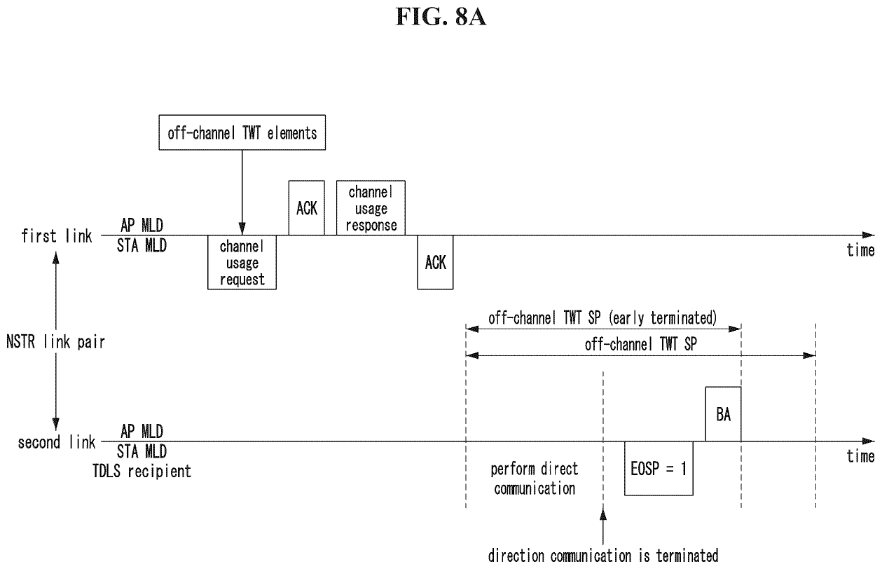

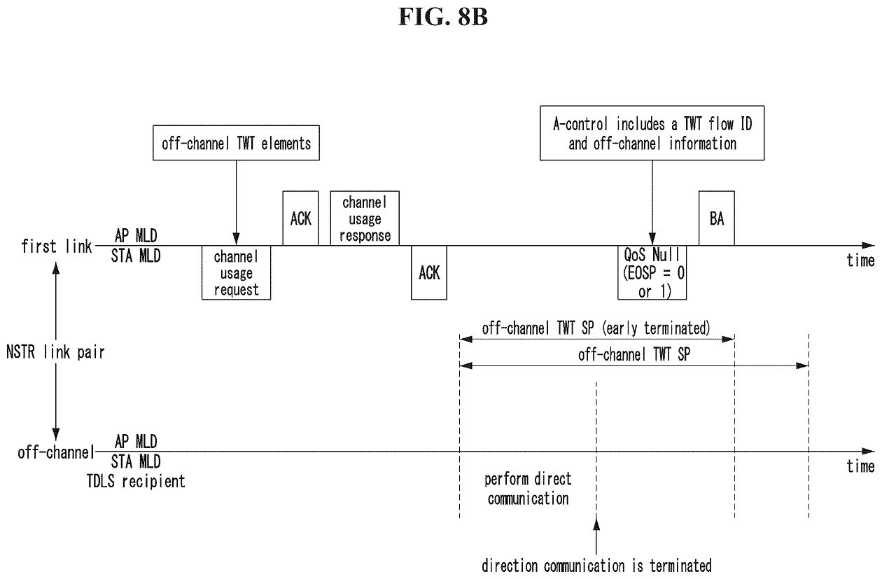

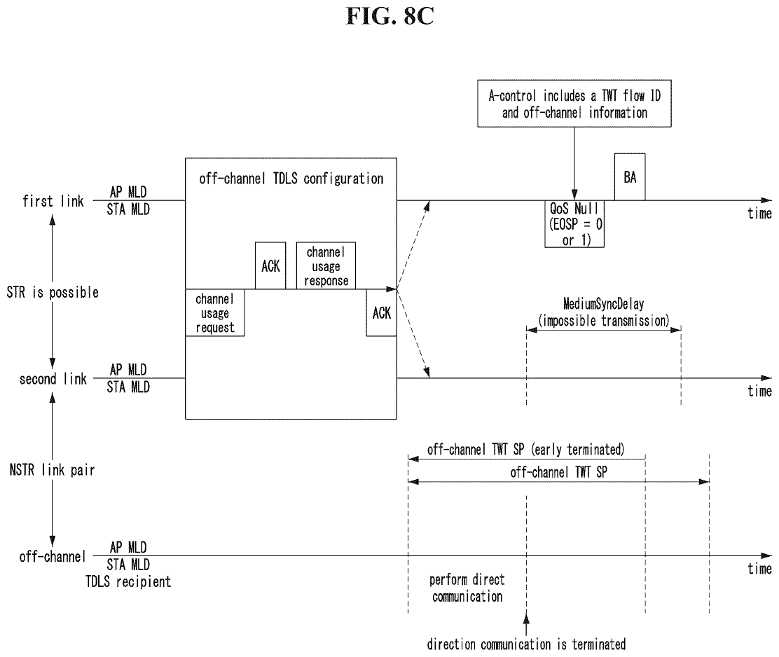

FIG. 8A is a timing diagram illustrating a fourth exemplary embodiment of a direct communication scheduling method in a wireless LAN, FIG. 8B is a timing diagram illustrating a fifth exemplary embodiment of a direct communication scheduling method in a wireless LAN, and FIG. 8C is a timing diagram illustrating a sixth exemplary embodiment of a direct communication scheduling method in a wireless LAN.

Referring to FIGS. 8A, 8B, and 8C, an AP MLD and a non-AP MLD (e.g., STA MLD) may operate on a multi-link. The STA MLD may perform direct communication (e.g., TDLS operation, TDLS communication) on a second link or a dedicated link (e.g., off-channel, off-link) for direction communication. The off-channel and off-link may have the same meaning. The second link may be one link of the multi-link on which the AP MLD and STA MLD operate. The off-channel may be a dedicated channel (e.g., dedicated link) for direct communication. A TDLS receiving STA (e.g., TDLS recipient) that is a target of direct communication may operate on the second link or off-channel. The AP MLD may not operate on the off-channel.

In the exemplary embodiment of FIG. 8A, the first link and the second link may be an NSTR link pair of the STA MLD. In the exemplary embodiment of FIG. 8B, the first link and the off-channel may be an NSTR link pair of the STA MLD. In the exemplary embodiment of FIG. 8C, the first link and the second link may be STR links (e.g., link(s) that are not an NSTR link pair) of the STA MLD, and the second link and the off-channel may be an NSTR pair of the STA MLD. On the STR links, the STA MLD may perform STR operations. The STA MLD may be an EMLSR STA MLD. In the exemplary embodiments of FIGS. 8A and 8B, the first link and the second link may be EMLSR links. In the exemplary embodiment of FIG. 8C, the first link and the second link may be STR links of the STA MLD, and the second link and the off-channel may be EMLSR links. Exemplary embodiments according to the present disclosure may be applied to an EMLSR STA MLD (e.g., EMLSR operations). For example, if the STA MLD is an EMLSR STA MLD and the first link and the second link are EMLSR links, operations on the first link and the second link may be the same as or similar to operations on an NSTR link pair.

The STA MLD may transmit a channel usage request frame to the AP MLD to perform direct communication. The AP MLD may receive the channel usage request frame from the STA MLD and identify information element(s) included in the channel usage request frame. The AP MLD may transmit a response frame for the channel usage request frame to the STA MLD. The channel usage request frame may be transmitted and received on the first link. The channel usage request frame may include information on a channel and/or link that the STA MLD wishes to use (e.g., information on the second link). In other words, the channel usage request frame may include information on a channel and/or link on which the STA MLD performs direct communication. The channel usage request frame may include one or more TWT information elements (e.g., TWT information, TWT elements). The TWT information elements may include a flow identifier (e.g., flow ID) that identifies a TWT request. The TWT information element(s) included in the channel usage request frame may indicate a TWT SP (e.g., off-channel TWT SP) in which the STA MLD wishes to perform direct communication.

The AP MLD may transmit a channel usage response frame to the STA MLD in response to the channel usage request frame. In other words, the AP MLD may determine a link and/or channel on which the STA MLD performs direct communication based on the information element(s) included in the channel usage request frame, and determine a TWP SP in which direct communication of the STA MLD is performed on the link and/or channel. The AP MLD may transmit to the STA MLD the channel usage response frame including information on the link and/or channel on which direct communication of the STA MLD is allowed and/or information on the TWT SP in which direct communication of the STA MLD is allowed. The STA MLD may receive the channel usage response frame from the AP MLD and identify the information element(s) included in the channel usage response frame. The STA MLD may transmit a response frame for the channel usage response frame to the AP MLD. The channel usage response frame may include information on the channel and/or link requested by the STA MLD. The channel usage response frame may include one or more TWT information elements. In other words, the TWT information element(s) included in the channel usage response frame may indicate the TWT SP (e.g., off-channel TWT SP, direct communication period) in which the STA MLD performs direct communication. The channel usage response frame may include a timeout interval element.

By exchanging the channel usage request/response frames including TWT information element(s) between the STA MLD and AP MLD, TWT configuration (e.g., TWT agreement) for TDLS between the STA MLD and AP MLD may be negotiated. The TWT configuration for TDLS may be referred to as an off-channel TWT or an off-channel TWT agreement. A TWT SP scheduled based on the off-channel TWT agreement may be referred to as an off-channel TWT SP or an off-channel TWT schedule. The off-channel TWT agreement may be used until a time indicated by the timeout interval element included in the channel usage response frame transmitted by the AP MLD. The AP MLD may not transmit a frame to the STA MLD on link(s) that have an NSTR link pair relationship with the link to which the off-channel TWT SP is applied during a time corresponding to the off-channel TWT SP.

Referring to FIG. 8A, the off-channel TWT SP may be scheduled on the second link. The STA MLD may perform direct communication (e.g., peer-to-peer communication, TDLS communication) with a TDLS recipient in the off-channel TWT SP of the second link. The direct communication may be terminated prematurely. In order to early terminate the direct communication in the off-channel TWT SP (or to early terminate the off-channel TWT SP when the direct communication is terminated), the STA MLD may transmit to the AP MLD a frame (hereinafter, ‘end of service period (EOSP) frame’) including a MAC header having an EOSP field set to a first value (e.g., 1). Alternatively, in order to early terminate the direct communication in the off-channel TWT SP (or to early terminate the off-channel TWT SP when the direct communication is terminated), the STA MLD may transmit an arbitrary frame to the AP MLD. The AP MLD may receive the EOSP frame or arbitrary frame from the STA MLD, and may transmit a response frame (e.g., ACK frame or BA frame) for the EOSP frame or arbitrary frame to the STA MLD, and terminate the off-channel TWT SP early. In addition, the STA MLD may early terminate the off-channel TWT SP after transmitting the EOSP frame or arbitrary frame.

Referring to FIG. 8B, the off-channel TWT SP may be scheduled on the off-channel. The STA MLD may perform direct communication (e.g., peer-to-peer communication, TDLS communication) with a TDLS recipient in the off-channel TWT SP of the off-channel. The direct communication may be terminated early. In order to early terminate the direct communication in the off-channel TWT SP (or to early terminate the off-channel TWT SP when the direct communication is terminated), the STA MLD may transmit to the AP MLD a quality of service (QoS) Null frame including a MAC header having an EOSP field set to a first value (e.g., 1). An A-control field of the MAC header included in the QoS Null frame may include information indicating a TWT flow identifier and/or the off-channel. The AP MLD may receive the QoS Null frame from the STA MLD, may transmit a response frame (e.g., ACK frame or BA frame) for the QoS Null frame to the STA MLD, and may terminate the off-channel TWT SP early. The STA MLD may early terminate the off-channel TWT SP after transmitting the QoS Null frame.

Alternatively, the STA MLD may transmit, on the first link, a clear to send (CTS)-to-Self frame including a receiver address (RA) field set to an address of the STA MLD on the first link. A duration of the CTS-to-Self frame may be set to 0. When the CTS-to-Self frame is received from the STA MLD, the AP MLD may early terminate the off-channel TWT SP. The STA MLD may early terminate the off-channel TWT SP after transmitting the CTS-to-Self frame.

Alternatively, the STA MLD may transmit a request to send (RTS) frame to the AP MLD (e.g., AP) on the first link. A duration of the RTS frame may be set to 0. When the RTS frame with a duration set to 0 is received from the STA MLD, the AP MLD may early terminate the off-channel TWT SP. The STA MLD may early terminate the off-channel TWT SP after transmitting the RTS frame. Alternatively, the duration of the RTS frame may be set to a time corresponding to (short interframe space (SIFS)+length of a CTS frame that is a response to the RTS frame). When the RTS frame with a duration set to the time corresponding to (SIFS+length of a CTS frame) is received from the STA MLD, the AP MLD may transmit a CTS frame to the STA MLD, and the AP MLD may early terminate the off-channel TWT SP. The STA MLD may early terminate the off-channel TWT SP after receiving the CTS frame for the RTS frame.

Alternatively, the STA MLD may transmit an arbitrary frame to the AP MLD on the first link. The AP MLD may receive the arbitrary frame from the STA MLD and early terminate the off-channel TWT SP. The STA MLD may early terminate the off-channel TWT SP after transmitting the arbitrary frame.

Referring to FIG. 8C, the off-channel TWT SP may be scheduled on the off-channel. The STA MLD may perform direct communication (e.g., peer-to-peer communication, TDLS communication) with a TDLS recipient in the off-channel TWT SP of the off-channel. The direct communication may be terminated early. After the direct communication is terminated, a MediumSyncDelay timer may operate on the second link that has an NSTR link pair relationship with the off-channel. In this case, the STA MLD may not be able to transmit to the AP MLD a frame for early termination of the direct communication in the off-channel TWT SP on the second link. In the above-described situation, in order to early terminate the direct communication in the off-channel TWT SP (or to early terminate the off-channel TWT SP when the direct communication is terminated), the STA MLD may transmit to the AP MLD a QoS Null frame including a MAC header having an EOSP field set to a first value (e.g., 1) on the first link that does not have an NSTR link pair relationship with the off-channel.

The MAC header included in the QoS Null frame may include information indicating a TWT flow identifier and/or the off-channel. For example, the MAC header of the QoS Null frame may include an A-control field, and the A-control field may include the information indicating the TWT flow identifier and/or off-channel. The AP MLD may receive the QoS Null frame from the STA MLD, may transmit a response frame (e.g., ACK frame or BA frame) for the QoS Null frame to the STA MLD, and may early terminate the off-channel TWT SP. The STA MLD may early terminate the off-channel TWT SP after transmitting the QoS Null frame. The STA MLD may generate a separate frame (e.g., TWT information frame or a frame including TWT elements) including the information indicating the TWT flow identifier and/or off-channel, and transmit an aggregate (A)-MPDU including the separate frame and the QoS Null frame.

Alternatively, the STA MLD may transmit, on the first link, a CTS-to-Self frame including an RA field set to an address of the STA MLD on the first link. A duration of the CTS-to-Self frame may be set to 0. When the CTS-to-Self frame is received from the STA MLD, the AP MLD may early terminate the off-channel TWT SP. The STA MLD may early terminate the off-channel TWT SP after transmitting the CTS-to-Self frame.

Alternatively, the STA MLD may transmit an RTS frame to the AP MLD (e.g., AP) on the first link. A duration of the RTS frame may be set to 0. When the RTS frame with a duration set to 0 is received from the STA MLD, the AP MLD may early terminate the off-channel TWT SP. The STA MLD may early terminate the off-channel TWT SP after transmitting the RTS frame. Alternatively, the duration of the RTS frame may be set to a time corresponding to (SIFS +length of a CTS frame that is a response to the RTS frame). When the RTS frame with a duration set to the time corresponding to (SIFS +length of a CTS frame) is received from the STA MLD, the AP MLD may transmit a CTS frame to the STA MLD, and the AP MLD may early terminate the off-channel TWT SP. The STA MLD may early terminate the off-channel TWT SP after receiving the CTS frame for the RTS frame.

Alternatively, the STA MLD may transmit an arbitrary frame to the AP MLD on the first link. The AP MLD may receive the arbitrary frame from the STA MLD and early terminate the off-channel TWT SP. The STA MLD may early terminate the off-channel TWT SP after transmitting the arbitrary frame.

In the exemplary embodiments of FIGS. 8A to 8C, the STA MLD may perform CCA within the MediumSyncDelay time of the second link, and an energy level detected by CCA may be equal to or less than a predetermined value. If the energy level is equal to or less than the predetermined value, the STA MLD may transmit an RTS frame to the TDLS recipient on the second link. If the STA MLD transmits the RTS frame, the MediumSyncDelay time may be terminated early, and the STA MLD may perform communication within the off-channel TWT SP.

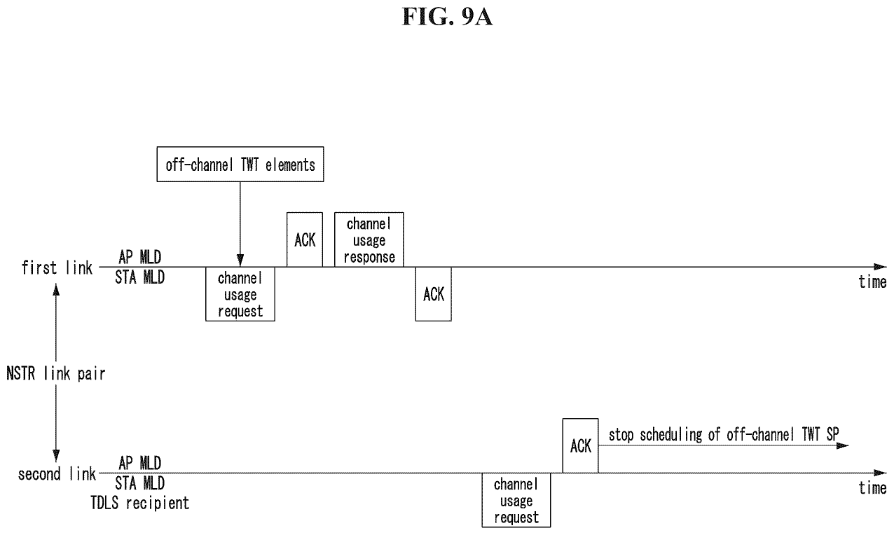

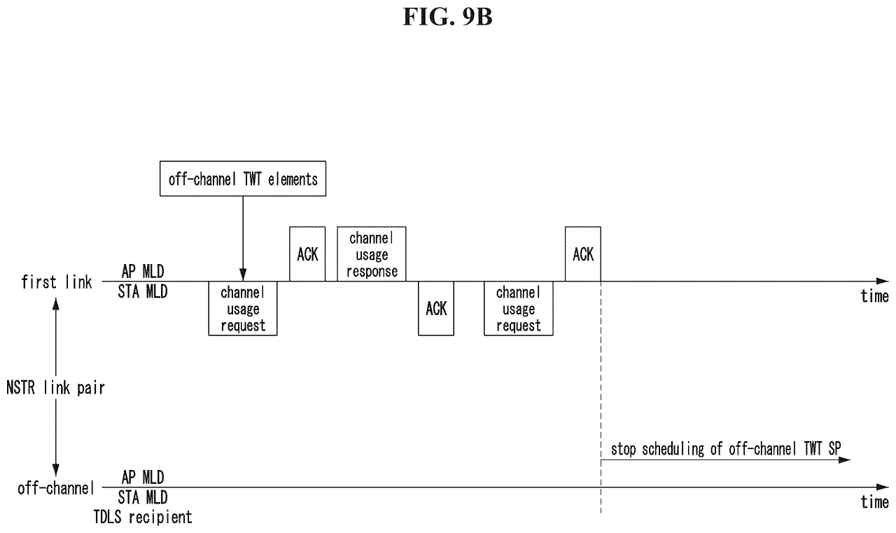

FIG. 9A is a timing diagram illustrating a seventh exemplary embodiment of a direct communication scheduling method in a wireless LAN, and FIG. 9B is a timing diagram illustrating an eighth exemplary embodiment of a direct communication scheduling method in a wireless LAN.

Referring to FIGS. 9A and 9B, an AP MLD and a non-AP MLD (e.g., STA MLD) may operate on a multi-link. The STA MLD may perform direct communication (e.g., TDLS operation, TDLS communication) on a second link or a dedicated link (e.g., off-channel, off-link) for direct communication. The off-channel and off-link may have the same meaning. The second link may be one link of the multi-link on which the AP MLD and STA MLD operate. The off-channel may be a dedicated channel (e.g., dedicated link) for direct communication. A TDLS receiving STA (e.g., TDLS recipient) that is a target of direct communication may operate on the second link or off-channel. The AP MLD may not operate on the off-channel.

In the exemplary embodiment of FIG. 9A, the first link and the second link may be an NSTR link pair of the STA MLD. In the exemplary embodiment of FIG. 9B, the first link and the off-channel may be an NSTR link pair of the STA MLD. The STA MLD may be an EMLSR STA MLD. The first link and the second link may be EMLSR links. Exemplary embodiments according to the present disclosure may be applied to an EMLSR STA MLD (e.g., EMLSR operations). For example, if the STA MLD is an EMLSR STA MLD and the first link and the second link are EMLSR links, operations on the first link and the second link may be the same as or similar to operations on an NSTR link pair.

The STA MLD may transmit a channel usage request frame to the AP MLD to perform direct communication. The AP MLD may receive the channel usage request frame from the STA MLD and identify information element(s) included in the channel usage request frame. The AP MLD may transmit a response frame for the channel usage request frame to the STA MLD. The channel usage request frame may be transmitted and received on the first link. The channel usage request frame may include information on a channel and/or link that the STA MLD wishes to use (e.g., information on the second link, information on the off-channel). In other words, the channel usage request frame may include information on a channel and/or link on which the STA MLD performs direct communication. The channel usage request frame may include one or more TWT information elements (e.g., TWT information, TWT elements). The TWT information elements may include a flow identifier (e.g., flow ID) that identifies a TWT request. A plurality of TWT information elements may include different TWT flow IDs. The TWT information element(s) included in the channel usage request frame may indicate a TWT SP (e.g., off-channel TWT SP) in which the STA MLD wishes to perform direct communication.

The AP MLD may transmit a channel usage response frame to the STA MLD in response to the channel usage request frame. In other words, the AP MLD may determine a link and/or channel on which the STA MLD performs direct communication based on the information element(s) included in the channel usage request frame, and determine a TWP SP in which direct communication of the STA MLD is performed on the link and/or channel. The AP MLD may transmit to the STA MLD the channel usage response frame including information on the link and/or channel on which direct communication of the STA MLD is allowed and/or information on the TWT SP in which direct communication of the STA MLD is allowed. The STA MLD may receive the channel usage response frame from the AP MLD and identify the information element(s) included in the channel usage response frame. The STA MLD may transmit a response frame for the channel usage response frame to the AP MLD. The channel usage response frame may include information on the channel and/or link requested by the STA MLD. In other words, the channel usage response frame may include information on the channel and/or link on which the STA MLD performs direct communication. The channel usage response frame may include one or more TWT information elements. In other words, the TWT information element(s) included in the channel usage response frame may indicate the TWT SP (e.g., off-channel TWT SP, direct communication period) in which the STA MLD performs direct communication. The channel usage response frame may include a timeout interval element.

By exchanging the channel usage request/response frames including TWT information element(s) between the STA MLD and AP MLD, TWT configuration (e.g., TWT agreement) for TDLS between the STA MLD and AP MLD may be negotiated. The TWT configuration for TDLS may be referred to as an off-channel TWT or an off-channel TWT agreement. A TWT SP scheduled based on the off-channel TWT agreement may be referred to as an off-channel TWT SP or an off-channel TWT schedule. The off-channel TWT agreement may be used until a time indicated by the timeout interval element included in the channel usage response frame transmitted by the AP MLD. The AP MLD may not transmit a frame to the STA MLD on link(s) that have an NSTR link pair relationship with the link to which the off-channel TWT SP is applied during a time corresponding to the off-channel TWT SP.

In the exemplary embodiments of FIGS. 9A and 9B, the STA MLD may wish to terminate (e.g., release) the off-channel TWT agreement established by the exchange procedure of channel usage request/response frames. To terminate the off-channel TWT agreement, the STA MLD may transmit a channel usage request frame including information indicating that a lifetime is 0 to the AP MLD. To identify the off-channel TWT agreement, a dialog token subfield of the channel usage request frame transmitted by the STA MLD may be set identically to a dialog token subfield of the channel usage request/response frames exchanged to establish the off-channel TWT agreement. The channel usage request frame may include one or more TWT information elements. Each TWT information element may include a TWT flow ID indicating a target of the termination.

Alternatively, in order to terminate the off-channel TWT agreement, the STA MLD may transmit a channel usage response frame to the AP MLD instead of a channel usage request frame. The channel usage response frame may include some or all of the information elements belonging to the channel usage request frame. The AP MLD may receive the channel usage request frame or channel usage response frame from the STA MLD, may identify that the lifetime is 0 based on the information included in the received frame, and may identify the TWT information element(s) and/or dialog token included in the received frame. The AP MLD may identify the off-channel TWT agreement for which the STA MLD requests termination, may cancel the off-channel TWT SP(s) scheduled by the off-channel TWT agreement for which termination is requested, and may no longer schedule an off-channel TWT SP.

In the exemplary embodiment of FIG. 9A, each of the channel usage request frame and channel usage response frame of the STA MLD may be transmitted on the first link or the second link. In the exemplary embodiment of FIG. 9B, each of the channel usage request frame and the channel usage response frame of the STA MLD may be transmitted on the first link (e.g., link on which both the AP MLD and the STA MLD operate) that is a link that is not the off-channel.

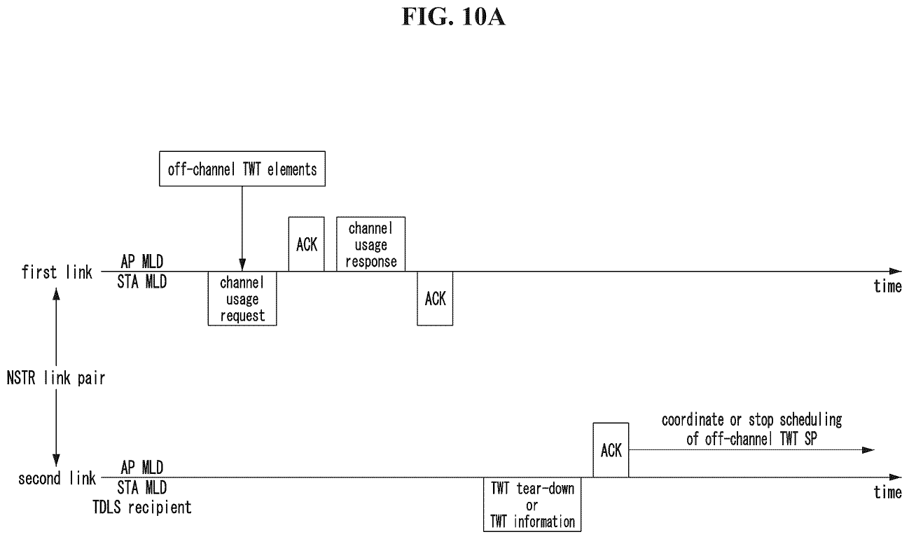

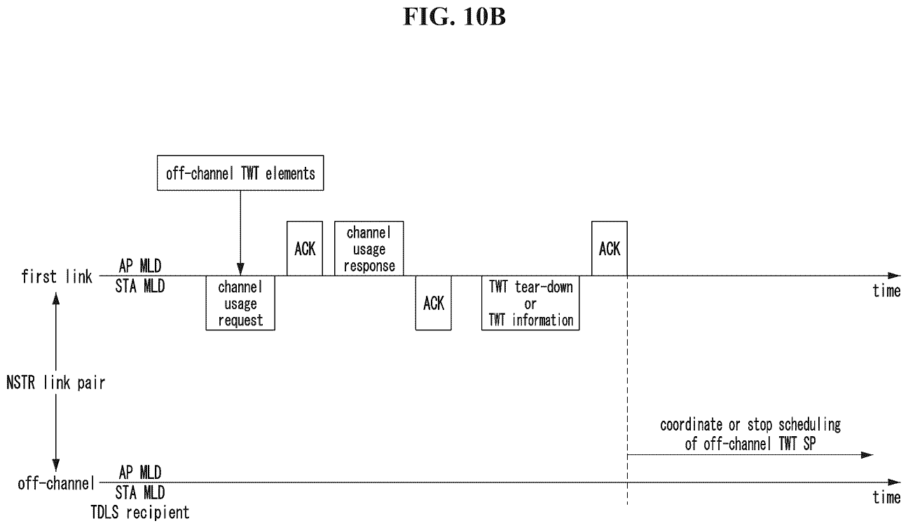

FIG. 10A is a timing diagram illustrating a ninth exemplary embodiment of a direct communication scheduling method in a wireless LAN, and FIG. 10B is a timing diagram illustrating a tenth exemplary embodiment of a direct communication scheduling method in a wireless LAN.

Referring to FIGS. 10A and 10B, an AP MLD and a non-AP MLD (e.g., STA MLD) may operate on a multi-link. The STA MLD may perform direct communication (e.g., TDLS operation, TDLS communication) on a second link or a dedicated link (e.g., off-channel, off-link) for direct communication. The off-channel and off-link may have the same meaning. The second link may be one link of the multi-link on which the AP MLD and STA MLD operate. The off-channel may be a dedicated channel (e.g., dedicated link) for direct communication. A TDLS receiving STA (e.g., TDLS recipient) that is a target of direct communication may operate on the second link or off-channel. The AP MLD may not operate on the off-channel.

In the exemplary embodiment of FIG. 10A, the first link and the second link may be an NSTR link pair of the STA MLD. In the exemplary embodiment of FIG. 10B, the first link and the off-channel may be an NSTR link pair of the STA MLD. The STA MLD may be an EMLSR STA MLD. The first link and the second link may be EMLSR links. Exemplary embodiments according to the present disclosure may be applied to an EMLSR STA MLD (e.g., EMLSR operations). For example, if the STA MLD is an EMLSR STA MLD and the first link and the second link are EMLSR links, operations on the first link and the second link may be the same as or similar to operations on an NSTR link pair.

The STA MLD may transmit a channel usage request frame to the AP MLD to perform direct communication. The AP MLD may receive the channel usage request frame from the STA MLD and identify information element(s) included in the channel usage request frame. The AP MLD may transmit a response frame for the channel usage request frame to the STA MLD. The channel usage request frame may be transmitted and received on the first link. The channel usage request frame may include information on a channel and/or link that the STA MLD wishes to use (e.g., information on the second link, information on the off-channel). In other words, the channel usage request frame may include information on a channel and/or link on which the STA MLD performs direct communication. The channel usage request frame may include one or more TWT information elements (e.g., TWT information, TWT elements). The TWT information elements may include a flow identifier (e.g., flow ID) that identifies a TWT request. A plurality of TWT information elements may include different TWT flow IDs. The TWT information element(s) included in the channel usage request frame may indicate a TWT SP (e.g., off-channel TWT SP) in which the STA MLD wishes to perform direct communication.

The AP MLD may transmit a channel usage response frame to the STA MLD in response to the channel usage request frame. In other words, the AP MLD may determine a link and/or channel on which the STA MLD performs direct communication based on the information element(s) included in the channel usage request frame, and determine a TWP SP in which direct communication of the STA MLD is performed on the link and/or channel. The AP MLD may transmit to the STA MLD the channel usage response frame including information on the link and/or channel on which direct communication of the STA MLD is allowed and/or information on the TWT SP in which direct communication of the STA MLD is allowed. The STA MLD may receive the channel usage response frame from the AP MLD and identify the information element(s) included in the channel usage response frame. The STA MLD may transmit a response frame for the channel usage response frame to the AP MLD. The channel usage response frame may include information on the channel and/or link requested by the STA MLD. In other words, the channel usage response frame may include information on the channel and/or link on which the STA MLD performs direct communication. The channel usage response frame may include one or more TWT information elements. In other words, the TWT information element(s) included in the channel usage response frame may indicate the TWT SP (e.g., off-channel TWT SP, direct communication period) in which the STA MLD performs direct communication. The channel usage response frame may include a timeout interval element.

By exchanging the channel usage request/response frames including TWT information element(s) between the STA MLD and AP MLD, TWT configuration (e.g., TWT agreement) for TDLS between the STA MLD and AP MLD may be negotiated. The TWT configuration for TDLS may be referred to as an off-channel TWT or an off-channel TWT agreement. A TWT SP scheduled based on the off-channel TWT agreement may be referred to as an off-channel TWT SP or an off-channel TWT schedule. The off-channel TWT agreement may be used until a time indicated by the timeout interval element included in the channel usage response frame transmitted by the AP MLD. The AP MLD may not transmit a frame to the STA MLD on link(s) that have an NSTR link pair relationship with the link to which the off-channel TWT SP is applied during a time corresponding to the off-channel TWT SP.

In the exemplary embodiments of FIGS. 10A and 10B, the STA MLD may wish to terminate (e.g., release) the off-channel TWT agreement established by the exchange procedure of channel usage request/response frames. In order to terminate the off-channel TWT agreement, the STA MLD may transmit a TWT tear-down frame to the AP MLD. The TWT tear-down frame transmitted from the STA MLD to the AP MLD may include a TWT flow ID to identify the off-channel TWT agreement that the STA MLD wishes to terminate. The AP MLD may receive the TWT tear-down frame from the STA MLD and may identify the off-channel TWT agreement that the STA MLD requests to terminate based on information (e.g., TWT flow ID) included in the TWT tear-down frame. The AP MLD may cancel the off-channel TWT SP(s) scheduled by the off-channel TWT agreement for which termination is requested, and may no longer schedule an off-channel TWT SP.

The STA MLD may wish to coordinate the off-channel TWT agreement established by the exchange procedure of channel usage request/response frames. In order to coordinate the off-channel TWT agreement, the STA MLD may transmit a TWT information frame to the AP MLD. The TWT information frame transmitted from the STA MLD to the AP MLD may include a TWT flow ID to identify the off-channel TWT agreement that the STA MLD wishes to coordinate. The AP MLD may receive the TWT information frame from the STA MLD, and may identify the off-channel TWT agreement for which the STA MLD requests coordination based on the information (e.g., TWT flow ID) included in the TWT information frame. The AP MLD may identify TWT parameters included in the TWT information frame, and schedule an off-channel TWT SP based on the TWT parameter(s) requested by the STA MLD.

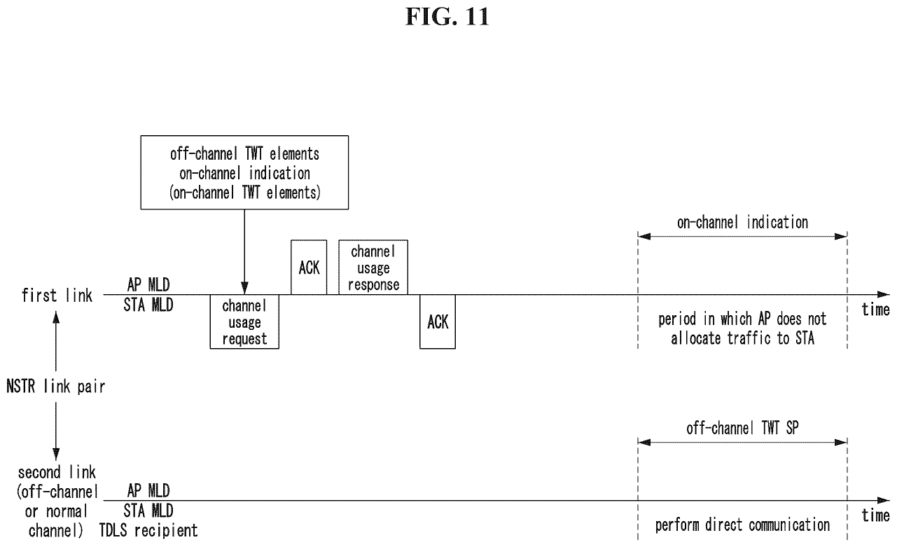

FIG. 11 is a timing diagram illustrating an eleventh exemplary embodiment of a direct communication scheduling method in a wireless LAN.

Referring to FIG. 11, an AP MLD and a non-AP MLD (e.g., STA MLD) may operate on a multi-link. The STA MLD may perform direct communication (e.g., TDLS operation, TDLS communication) on a second link. The second link may be one link of the multi-link on which the AP MLD and STA MLD operate. Alternatively, the second link may be a dedicated channel (e.g., dedicated link) for direct communication. A TDLS receiving STA (e.g., TDLS recipient) that is a target of direct communication may operate on the second link. The AP MLD may not operate on the off-channel.

The first link and the second link may be an NSTR link pair of the STA MLD. The STA MLD may be an EMLSR STA MLD. The first link and the second link may be EMLSR links. Exemplary embodiments according to the present disclosure may be applied to an EMLSR STA MLD (e.g., EMLSR operations). For example, if the STA MLD is an EMLSR STA MLD and the first link and the second link are EMLSR links, operations on the first link and the second link may be the same as or similar to operations on an NSTR link pair.

The STA MLD may transmit a channel usage request frame to the AP MLD to perform direct communication. The AP MLD may receive the channel usage request frame from the STA MLD and identify information element(s) included in the channel usage request frame. The AP MLD may transmit a response frame for the channel usage request frame to the STA MLD. The channel usage request frame may be transmitted and received on the first link. The channel usage request frame may include information on a channel and/or link that the STA MLD wishes to use (e.g., information on the second link, information on the off-channel). In other words, the channel usage request frame may include information on a channel and/or link on which the STA MLD performs direct communication. The direct communication may be communication between STAs. The channel usage request frame may include one or more TWT information elements (e.g., TWT information, TWT elements). The TWT information elements may include a flow identifier (e.g., flow ID) that identifies a TWT request. The TWT information elements may include TWT information for a channel and/or link that the STA MLD (e.g., STA) wishes to use and/or TWT information for a channel and/or link on which transmission of the AP MLD (e.g., AP) is prohibited.

The AP MLD may transmit a channel usage response frame to the STA MLD in response to the channel usage request frame. The STA MLD may receive the channel usage response frame from AP MLD. The STA MLD may transmit a response frame for the channel usage response frame to the AP MLD. The channel usage response frame may include information on a channel and/or link requested by the STA MLD. The channel usage response frame may include one or more TWT information elements. The TWT information elements of the channel usage response frame may include TWT information for a channel and/or link that the STA MLD (e.g., STA) wishes to use and/or TWT information for a channel and/or link on which transmission of the AP MLD (e.g., AP) is prohibited. The channel usage response frame may include a timeout interval element.

By exchanging the channel usage request/response frames including TWT information element(s) between the STA MLD and AP MLD, TWT configuration (e.g., TWT agreement) for TDLS between the STA MLD and AP MLD may be negotiated. The TWT configuration for TDLS may be referred to as an off-channel TWT or an off-channel TWT agreement. A TWT SP scheduled based on the off-channel TWT agreement may be referred to as an off-channel TWT SP or an off-channel TWT schedule. While the STA MLD is performing TDLS communication, the TWT configuration on the link on which the AP MLD is prohibited from transmitting frames to the STA MLD may be referred to as an on-channel TWT agreement. A TWT SP scheduled based on the on-channel TWT agreement may be referred to as an on-channel indication. The off-channel TWT agreement and the on-channel TWT agreement may be used until a time indicated by the timeout interval element included in the channel usage response frame transmitted by the AP MLD. The AP MLD may not transmit frames to the STA MLD on link(s) that have an NSTR link pair relationship with the link to which the off-channel TWT SP is applied during a time corresponding to the off-channel TWT SP. The AP MLD may not transmit frames to the STA MLD on the link(s) to which the on-channel indication is applied.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a station multi-link device (STA MLD), the method comprising:
transmitting a first frame including a request for use of a link for direct communication to an access point (AP) MLD on a first link;
receiving a second frame from the AP MLD on the first link in response to the request for use of the link for direct communication; and
performing direct communication in a target wake time (TWT) service period (SP) of a second link, which is configured by an exchange procedure of the first frame and the second frame.

2. The method of claim 1, wherein the first frame includes information on at least one of the second link on which the STA MLD wishes to perform the direct communication or the TWT SP.

3. The method of claim 1, wherein the second frame includes information on at least one of the second link on which the direct communication of the STA MLD is allowed or the TWT SP.

4. The method of claim 1, further comprising: before the TWT SP, performing communication with the AP MLD in a transmit opportunity (TXOP) on one link among the first link and the second link, wherein in response that the first link and the second link are a non-simultaneous transmit and receive (NSTR) link pair, the TXOP is configured to be terminated before a MediumSyncDelay time from a start time of the TWT SP, or the TXOP is early terminated before the MediumSyncDelay time from the start time of the TWT SP.

5. The method of claim 1, further comprising: before the TWT SP, performing communication with the AP MLD in a TXOP on one link among the first link and the second link, wherein in response that the first link and the second link are an NSTR link pair, and the STA MLD is an enhanced multi-link single radio (EMLSR) MLD, the TXOP is configured to be terminated before (MediumSyncDelay time+EMLSR transition time) from a start time of the TWT SP, or the TXOP is early terminated before (MediumSyncDelay time+EMLSR transition time) from the start time of the TWT SP.

6. The method of claim 1, wherein the STA MLD does not expect to receive a frame from the AP MLD on the first link that has an NSTR link pair relationship with the second link, during a time corresponding to the TWT SP of the second link.

7. The method of claim 1, wherein in response that the first link and the second link are an NSTR link pair, the TWT SP is configured to include a MediumSyncDelay time, and the direct communication is performed in a time remaining after the MediumSyncDelay time is terminated within the TWT SP.

8. The method of claim 1, wherein in response that the first link and the second link are an NSTR link pair, and the TWT SP partially overlaps with a MediumSyncDelay time, the direct communication is performed in a time corresponding to (a part of the TWP SP that does not overlap the MediumSyncDelay time+an additional time allocated by the AP MLD).

9. The method of claim 1, further comprising:
in response that the direct communication is terminated, transmitting a third frame for early terminating the TWT SP; and
early terminating the TWT SP after transmission of the third frame.

10. A method of an access point multi-link device (AP MLD), the method comprising:
receiving a first frame including a request for use of a link for direct communication from a station (STA) MLD on a first link;
determining a second link on which the direct communication is to be performed and a target wake time (TWT) service period (SP) based on information included in the first frame; and
transmitting a second frame including information of the second link and information of the TWT SP to the STA MLD on the first link,
wherein the AP MLD does not perform communication with the STA MLD on the first link that has a non-simultaneous transmit and receive (NSTR) link pair relationship with the second link, during a time corresponding to the TWT SP of the second link.

11. The method of claim 10, further comprising: before the TWT SP, performing communication with the STA MLD in a transmit opportunity (TXOP) on one link among the first link and the second link, wherein the TXOP is configured to be terminated before a MediumSyncDelay time from a start time of the TWT SP, or the TXOP is early terminated before the MediumSyncDelay time from the start time of the TWT SP.

12. The method of claim 10, further comprising: before the TWT SP, performing communication with the STA MLD in a TXOP on one link among the first link and the second link, wherein in response that the STA MLD is an enhanced multi-link single radio (EMLSR) MLD, the TXOP is configured to be terminated before (MediumSyncDelay time+EMLSR transition time) from a start time of the TWT SP, or the TXOP is early terminated before (MediumSyncDelay time +EMLSR transition time) from the start time of the TWT SP.

13. The method of claim 10, further comprising: in response that the first link and the second link are an NSTR link pair, and the TWT SP overlaps with a MediumSyncDelay time, allocating an additional time to the STA MLD, wherein the direct communication of the STA MLD is performed in a time corresponding to (a part of the TWP SP that does not overlap the MediumSyncDelay time +the additional time allocated by the AP MLD).

14. The method of claim 10, further comprising:
in response that the direct communication is terminated, receiving a third frame for early terminating the TWT SP from the STA MLD; and
early terminating the TWT SP after reception of the third frame.

15. A station multi-link device (STA MLD) comprising at least one processor, wherein the at least one processor causes the STA MLD to perform:
transmitting a first frame including a request for use of a link for direct communication to an access point (AP) MLD on a first link;
receiving a second frame from the AP MLD on the first link in response to the request for use of the link for direct communication; and
performing direct communication in a target wake time (TWT) service period (SP) of a second link, which is configured by an exchange procedure of the first frame and the second frame.

16. The STA MLD of claim 15, wherein the at least one processor further causes the STA MLD to perform: before the TWT SP, performing communication with the AP MLD in a transmit opportunity (TXOP) on one link among the first link and the second link, wherein in response that the first link and the second link are a non-simultaneous transmit and receive (NSTR) link pair, the TXOP is configured to be terminated before a MediumSyncDelay time from a start time of the TWT SP, or the TXOP is early terminated before the MediumSyncDelay time from the start time of the TWT SP.

17. The STA MLD of claim 15, wherein the at least one processor further causes the STA MLD to perform: before the TWT SP, performing communication with the AP MLD in a TXOP on one link among the first link and the second link, wherein in response that the first link and the second link are an NSTR link pair, and the STA MLD is an enhanced multi-link single radio (EMLSR) MLD, the TXOP is configured to be terminated before (MediumSyncDelay time +EMLSR transition time) from a start time of the TWT SP, or the TXOP is early terminated before (MediumSyncDelay time +EMLSR transition time) from the start time of the TWT SP.

18. The STA MLD of claim 15, wherein in response that the first link and the second link are an NSTR link pair, the TWT SP is configured to include a MediumSyncDelay time, and the direct communication is performed in a time remaining after the MediumSyncDelay time is terminated within the TWT SP.

19. The STA MLD of claim 15, wherein in response that the first link and the second link are an NSTR link pair, and the TWT SP partially overlaps with a MediumSyncDelay time, the direct communication is performed in a time corresponding to (a part of the TWP SP that does not overlap the MediumSyncDelay time+an additional time allocated by the AP MLD).

20. The STA MLD of claim 15, wherein the at least one processor further causes the STA MLD to perform:
in response that the direct communication is terminated, transmitting a third frame for early terminating the TWT SP; and
early terminating the TWT SP after transmission of the third frame.
